(19) United States
(12) Patent Application Publication
(10) Pub. No.: US 2011/0309217 A1
(43) Pub. Date: Dec. 22, 2011

(54) MAGNETIC ATTACHMENT SYSTEM FOR SECURING VESSELS TO A SHAKER

(76) Inventor: Anthony Demsia, South Plainfield, NJ (US)

(21) Appl. No.: 13/159,713

(22) Filed: Jun. 14, 2011

Related U.S. Application Data
(60) Provisional application No. 61/356,221, filed on Jun. 18, 2010.

(51) Int. Cl. F16M 13/02; H01F 7/02; B23P 11/00

(52) U.S. Cl. 248/206.5; 29/525.03

(57) ABSTRACT

A magnetic attachment system for securing vessels to a shaker includes a vessel holder, adapted to retain the vessel; a magnet, adapted to magnetically attach to the shaker; and an attachment mechanism adapted to retain the holder to the magnet, thereby releasably retaining the vessel to the shaker. The system may include an insulating mat between a metal platform of the shaker and the magnet.

### RELATED APPLICATIONS

This application claims the benefit of the filing date of U.S. Patent Application No. 61/356,221, filed Jun. 18, 2010, which is incorporated herein by reference in its entirety.

### BACKGROUND OF THE INVENTION

The present invention generally relates to magnetic platforms and more specifically to magnetic attachment system for securing vessels to a shaker.

Existing laboratory vessel shakers may take time and work to attach flask holders to laboratory shaking or mixing platforms, and may require additional screws or tools. Current technology requires the vessel holder to be attached with the use of screws, nuts and/or other tools. The current system requires tools and hardware such as screws, nuts, bolts, etc. Tools and hardware are not readily available in the laborites that use shakers. In addition, the process of using these tools is time consuming.

It would be desirable to use magnetism to securely attach a vessel holder to a metallic shaker platform.

### SUMMARY OF THE INVENTION

In one aspect of the present invention, a device for a vessel and a metal shaker platform includes a magnet; and an attachment mechanism adapted to retain the vessel to the magnet; wherein the magnet is adapted to magnetically attach to the platform, thereby releasably retaining the vessel to the platform.

In another aspect of the present invention, a magnetic attachment system for securing vessels to a shaker includes a vessel holder, adapted to retain the vessel; a magnet, adapted to magnetically attach to the shaker; and an attachment mechanism adapted to retain the holder to the magnet, thereby releasably retaining the vessel to the shaker.

In yet another aspect of the present invention, a method of retaining a vessel to a metal shaker platform includes attaching a magnet to a holder for the vessel, thereby providing a holder assembly; holding the vessel with the holder assembly; and placing the holder assembly upon the platform so as to releasably retain the magnet to the platform.

### BRIEF DESCRIPTION OF THE DRAWINGS

FIG. 1 depicts an exploded view of an embodiment of a flask holder assembly according to the present invention; and

FIG. 2 depicts an embodiment of a magnetic attachment system according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a magnetic attachment system for securing flasks and other laboratory glassware, plastic ware and vessels to the form of a laboratory shaker or mixer.

An embodiment may secure flasks and other laboratory vessels to a shaking platform without the necessity to use additional screws or tools, with the use of magnetism to securely attach the vessel holder to a metallic shaker platform. Embodiments may reduce the time and work associated with the current systems for attaching flask holders to laboratory shaking or mixing platforms.

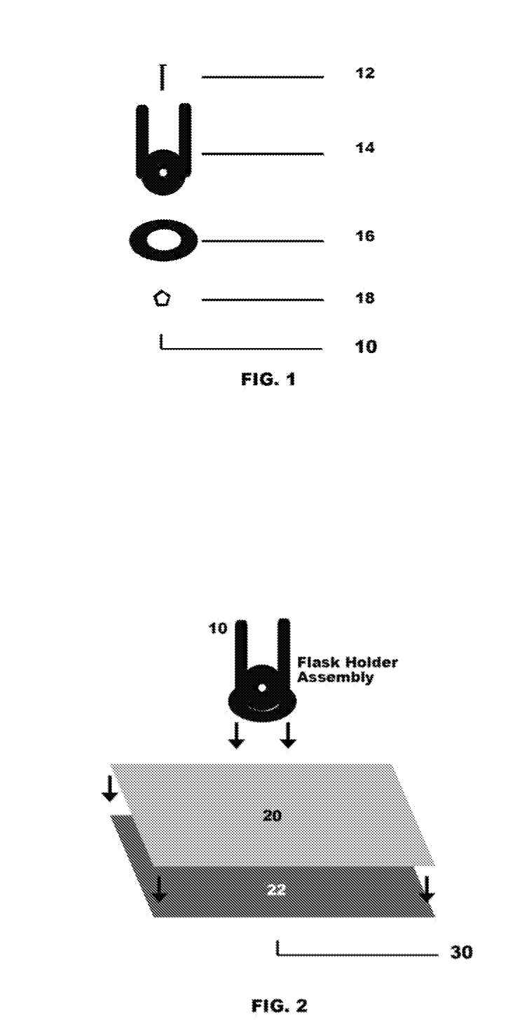

As depicted in the embodiment of FIG. 1, an embodiment of a flask holder assembly 10 may include a screw 12, a flask holder 14, a magnet 16, and a securing nut 18. In an embodiment, the screw 12 passes through an aperture in the flask holder 14, and the securing nut 18 retains the magnet 16 against the bottom of the flask holder 14. The magnet may include iron, nickel, or another magnetic material capable of providing a permanent magnet.

As depicted in the embodiment of FIG. 2, embodiments of a magnetic attachment system 30 may be secured to a rubber mat 20 or other insulating mat that is placed on a steel plate 22 or other iron or magnetic-metal shaker platform. This rubber mat 20 may reduce the magnetic attraction, making it easier to remove the vessel holder's assembly 10. In addition, the rubber mat 20 may protect the metallic platform 22 from scratching, denting or other damage. The insulating mat may be substantially made of rubber or other materials that provide magnetic insulation. The magnetic-metal platform may include steel or other materials that can be attracted to a permanent magnet. The magnetic-metal platform itself does not necessarily have a permanent magnetic field, but should be attracted to the magnetic material in the flask holder assembly 10.

An embodiment of the present invention may utilize magnetic attraction to replace hardware and tools, and may be used in different formats regarding the placement of the magnet itself. The magnet may be an integral part of the vessel holder or clamp, or may be attached above or below the shaking platform.

Embodiments of the present invention may utilize magnets to attach a flask or vessel to a shaker platform. The vessel may be a flask, tube, laboratory vessel, or other container that is to be shaken. Embodiments may include a high powered magnet that may be secured to the vessel or to a vessel holder. A magnet may be screwed to the base of the vessel holder. The vessel holder may be securely fastened to a metallic, laboratory shaking or mixing platform by making contact between the magnet and the platform.

A person (for example, in a laboratory) may use embodiments of the invention to attach a flask or other vessels to a laboratory shaker or mixer platform. A user may attach a magnet to a holder for the vessel, to provide a holder assembly, hold the vessel with the holder assembly, and place the holder assembly upon the platform so as to releasably retain the magnet to the platform.

Embodiments may include a method of retaining a vessel to a shaker platform, comprising: providing a holder that includes magnetic material; holding the vessel with the holder; and utilizing magnetism to attach the magnetic material in the holder to the shaker platform, thereby retaining the vessel to the shaker platform.

I claim:

1. A device for a vessel and a metal shaker platform, comprising:
a magnet; and
an attachment mechanism adapted to retain the vessel to the magnet;
wherein the magnet is adapted to magnetically attach to the platform, thereby releasably retaining the vessel to the platform.

2. The device of claim 1, further comprising a vessel holder, wherein the attachment mechanism attaches to the holder and the holder retains the vessel.

3. The device of claim 2, wherein the magnet is attached to a base of the holder so that the vessel is retained above the magnet, and the magnet is attached to the platform so that the vessel is retained above the platform.

4. The device of claim 1, wherein the attachment mechanism includes a screw that passes through an aperture in the holder and a nut adapted to attach to the screw, thereby attaching the magnet to the holder.

5. The device of claim 1, wherein the magnet is fixed to the vessel.

6. The device of claim 1, wherein the magnet is fixed to the platform.

7. The device of claim 1, wherein the magnet is a permanent magnet.

8. The device of claim 1, further comprising an insulating mat between the platform and the magnet.

9. A magnetic attachment system for securing vessels to a shaker, comprising:
a vessel holder, adapted to retain the vessel;
a magnet, adapted to magnetically attach to the shaker; and
an attachment mechanism adapted to retain the holder to the magnet, thereby releasably retaining the vessel to the shaker.

10. The device of claim 9, further comprising an insulating mat between a metal platform of the shaker and the magnet.

11. A method of retaining a vessel to a metal shaker platform, comprising:
attaching a magnet to a holder for the vessel, thereby providing a holder assembly;
holding the vessel with the holder assembly; and
placing the holder assembly upon the platform so as to releasably retain the magnet to the platform.
